(19) United States
(12) Patent Application Publication
(10) Pub. No.: US 2012/0237102 A1
(43) Pub. Date: Sep. 20, 2012

(54) System and Method for Improving Acquired Ultrasound-Image Review

(76) Inventors: Eric Savitsky, Malibu, CA (US); Dan Katz, Encino, CA (US)

(21) Appl. No.: 13/481,703

(22) Filed: May 25, 2012

Related U.S. Application Data
(63) Continuation-in-part of application No. 13/243,758, filed on Sep. 23, 2011.
Application No. 13/243,758 is a continuation of application No. 11/720,515, filed on May 30, 2007, now abandoned.
(60) Provisional application No. 60/631,488, filed on Nov. 30, 2004.

(51) Int. Cl. G06K 9/00

(52) U.S. Cl. 382/131

(57) ABSTRACT

A system for creating 3D ultrasound case volumes from 2D scans and aligning the ultrasound case volumes with a virtual representation of a body to create an adapted virtual body that is scaled and accurately reflects the morphology of a particular patient. The system improves a radiologist's or treating physician's ability to examine and interact with a patient's complete ultrasound case volume independent of the patient, the type of ultrasound machine used to acquire the original data, and the original scanning session.

### CROSS-REFERENCES TO RELATED APPLICATIONS

This patent application is a continuation-in-part and claims the benefit of U.S. patent application Ser. No. 13/243,758 filed Sep. 23, 2011 for Multimodal Ultrasound Training System, which is a continuation of U.S. patent application Ser. No. 11/720,515 filed May 30, 2007 for Multimodal Medical Procedure Training System, which is the national stage entry of PCT/US05/43155, entitled “Multimodal Medical Procedure Training System” and filed Nov. 30, 2005, which claims priority to U.S. Provisional Patent Application No. 60/631,488, entitled Multimodal Emergency Medical Procedural Training Platform and filed Nov. 30, 2004. Each of those applications is incorporated here by this reference.

This patent application also claims the benefit of U.S. Provisional Application Ser. No. 61/491,126 filed May 27, 2011 for Data Acquisition, Reconstruction, and Simulation; U.S. Provisional Application Ser. No. 61/491,131 filed May 27, 2011 for Data Validator; U.S. Provisional Application Ser. No. 61/491,134 filed May 27, 2011 for Peripheral Probe with Six Degrees of Freedom Plus 1; U.S. Provisional Application Ser. No. 61/491,135 filed May 27, 2011 for Patient-Specific Advanced Ultrasound Image Reconstruction Algorithms; and U.S. Provisional Application Ser. No. 61/491,138 filed May 27, 2011 for System and Method for Improving Acquired Ultrasound-Image Review. Each of those applications is incorporated here by this reference.

### TECHNICAL FIELD

This invention relates to the process of conducting ultrasound scans and more particularly to a methodology for taking and using ultrasound images directly in the clinical environment to assist in the treatment of patients.

### BACKGROUND ART

Traditional two-dimensional (“2D”) medical ultrasound produces a diagnostic image by broadcasting high-frequency acoustic waves through anatomical tissues and by measuring the characteristics of the reflected oscillations. In 2D ultrasound, the waves are typically reflected directly back at the ultrasound transducer. 2D ultrasound, images are acquired using a handheld sonographic transducer (ultrasound probe) and are always restricted to a relatively small anatomical region due to the small footprint of the imaging surface. The operator of the ultrasound device (technologist, radiographer, or sonographer) must place the probe on the patient's body at the desired location and orient it carefully so that the anatomical region of interest is clearly visible in the ultrasound output.

In three-dimensional (“3D”) ultrasound, high frequency sound waves are directed into the patient's body at multiple angles and thus produce reflections at multiple angles. The reflected waves are processed by using complex algorithms implemented on a computer which result in a reconstructed three-dimensional view of the internal organs or tissue structures being investigated. 3D ultrasound allows one to see ultrasound images at arbitrary angles within the captured anatomical region. Complex interpolation algorithms even allow one to see ultrasound images at angles that were not scanned directly with the ultrasound device.

Four-dimensional (“4D”) ultrasound is similar to 3D ultrasound. But 4D ultrasound uses an array of 2D transducers to capture a volume of ultrasound all at once. 3D ultrasound, in contrast, uses a single 2D transducer and combines multiple 2D ultrasound images to form a 3D volume. One problem with 3D ultrasound is that these 2D images are taken individually at different times; so the technology does not work well for imaging dynamic organs, such as the heart or lung, that change their shape rapidly.

Accordingly, one of the primary benefits of 4D ultrasound imaging compared to other diagnostic techniques is that it allows the 3D volume capture of an anatomical region that changes rapidly during the process of scanning, such as the heart or lungs

FIG. 1 shows the prior art workflow for ultrasound imaging. In step 1, a patient is prepared for ultrasound examination. In step 2, selected 2D ultrasound snapshots or possibly a 3D ultrasound video is produced. In step 3, a radiologist will review the ultrasound images at a reviewing station. In step 4, if the images are satisfactory, they are sent on for medical diagnosis. If the images are unacceptable, the ultrasound scanning process is repeated.

In the current clinical workflow, when a radiologist is asked to review an ultrasound examination, he or she is typically presented with either a collection of static two-dimensional snapshots or a pre-recorded video of the complete ultrasound session. And the review occurs away from the ultrasound machine and the patient. In both cases, the reviewer (e.g., radiologist) cannot take advantage of one of the most important features of ultrasound imaging, which is the ability to navigate and interact with the patient's anatomy in real-time. Real-time analysis allows the radiologist to investigate anatomic structures from multiple angles and perspectives.

This major shortcoming greatly limits the ability of a radiologist to correctly diagnose clinical pathologies when the ultrasound machinery and patient are not readily available for real-time scanning. Consequently, if questions exist with regards to a particular image, the patient may be asked to return for additional image acquisition to enable the radiologist to observe and direct the ultrasound examination while it is being taken, in real-time.

In addition, interventional radiologists, surgeons, and a progressively higher proportion of overall physicians (e.g., emergency medicine practitioners) frequently rely upon real-time ultrasound image guidance for performance of needle-based procedures (e.g., tumor biopsies and the like). Moreover, opportunities for pre-procedural rehearsal of needle-based procedures under ultrasound-image guidance using the patient's anatomical imagery do not exist. Thus, practitioners are forced to perform these procedures on actual patients without the benefits of prior procedural rehearsal on simulated patient imagery.

A majority of ultrasound machines used in point-of-care (clinical) settings only have 2D imaging ability. These machines have no ability to acquire and reconstruct complete 3D volumes of ultrasound data. Hence, reviewers of data obtained from these units must rely on 2D ultrasound video clips and still images acquired by an ultrasound technologist for making diagnoses. Users of such machines do not have the ability to interact with 3D ultrasound data sets (e.g., study and analyze anatomic structures from multiple angles and perspectives) or perform pre-procedural rehearsal or actual procedures using real-time ultrasound image-guidance.

Only a small subset of currently available ultrasound machines possesses 3D or 4D imaging ability. These machines have a large physical footprint and are expensive. Current solutions for storing ultrasound data in a volumetric form (ultrasound volumes) include constructing ultrasound 3D volumes: (1) by registering multiple two-dimensional (2D) slices acquired by a traditional 2D ultrasound scanner into a 3D volume with the aid of motion control; (2) using modern 3D or 4D scanners that capture collections of closely spaced 2D slices by means of multiple synchronized transducers (phased-array transducers).

Once data is stored in a volumetric format, specialized software embedded in select ultrasound machines (that is, the most advanced and expensive) allow an operator to interact with the ultrasound imagery in a variety of ways (e.g., measure areas of interest or correlate with spatially registered computed tomography imaging). Unfortunately, these current workflow solutions do not allow an operator to scan through the acquired 3D ultrasound data set (that is, view slices at arbitrary angles) in a manner that resembles the process of real-time scanning of the patient and interacting with the data for purposes of diagnostic imaging or pre-procedural rehearsal training of ultrasound image-guided needle-based interventions. Additionally, the ability to interact with the data is very limited in existing solutions.

The ultrasound volumes are not embedded in any virtual body model, nor is there an affixed or integrated ultrasound probe that allows for interaction with the embedded ultrasound volumes in a manner that is intuitive or resembles actual patient-based ultrasonography. The data currently appears on the ultrasound unit independent of clinical context, i.e., location of the data set within the patient's body.

### DISCLOSURE OF INVENTION

The exemplary embodiment of the present invention is an improved ultrasound imaging system and software. The system of the present invention is capable of creating 3D ultrasound case volumes from 2D scans and aligning the ultrasound case volumes with a virtual representation of a body to create an adapted virtual body that is scaled and accurately reflects the morphology of a particular patient. The system improves an operator's ability to examine and interact with a patient's complete ultrasound case volume independent of the patient, the type of ultrasound machine used to acquire the original data, and the original scanning session. That is, the reviewer can interact with the data at the time of his or her choosing. The disclosed method for real-time reconstruction and creation of complete 3D ultrasound data sets using low-cost widely available 2D ultrasound machines expands the aforementioned benefits to a broad spectrum of clinical settings, ultrasound machines, and operators.

It is an object of the present invention to provide an improved ability to scan through and interact with a complete 3D volume of ultrasound imagery, rather than being restricted to a small collection of static images or a 2D video clip established at the time of capture. This improves the diagnostic ability of a reviewer to correctly diagnose clinical pathologies when the ultrasound machinery and patient are not readily available for real-time scanning.

It is another object of the present invention to extend the capabilities of low-cost, widely available 2D ultrasound machines to include delivery of 3D ultrasound case volumes that will extend the aforementioned benefits to a broad spectrum of clinical settings, ultrasound machines, and operators.

It is also an object of the present invention to improve efficiency and workflow in the ultrasound imaging process. This is accomplished by extending the operator's ability to examine and interact with a patient's complete ultrasound data, independent of the patient and type of ultrasound machine (2D or 3D) used for data acquisition, and decoupling the ability to review a case from the original scanning session. That is, the reviewer can interact with the data at the time of his/her choosing. This mitigates the need to have a patient return for additional imaging with a radiologist at the bedside to observe and direct the ultrasound examination, which frequently occurs when still ultrasound imagery and video clips are used for post-image acquisition review.

It is a further object of the invention to provide improved patient safety through pre-procedural rehearsal. Patient care is improved by creating an opportunity for pre-procedural rehearsal of needle-based procedures under ultrasound-image guidance using a patient's anatomical imagery. Doctors will be able to practice and rehearse needle-based surgical procedures using real-time ultrasound image guidance on a patient's anatomic ultrasound data prior to actually performing the procedure.

### BRIEF DESCRIPTION OF DRAWINGS

FIG. 1 is a schematic representation of the ultrasound imaging work flow of the prior art.

FIG. 2 is a schematic representation of the ultrasound imaging work flow of the present invention.

FIG. 3 is a slice of an exemplary ultrasound volume in accordance with the present invention.

FIG. 4 is a schematic representation of the system in accordance with the present invention for creating a virtual ultrasound patient model by embedding an actual patient's ultrasound imagery with that of a generic virtual model.

FIG. 5 is a schematic representation of methods of achieving body alignment, i.e. of spatially aligning ultrasound volumes with the patient's simulated body.

### BEST MODE FOR CARRYING OUT THE INVENTION

The present invention will now be described more fully with reference to the exemplary embodiment and the accompanying drawings. The exemplary embodiment of this invention refers to improved ultrasound imaging workflow in a clinical environment, as well as to an acquisition and processing system 20 which includes the ability to create 3D ultrasound volumes from 2D scans; perform 3D simulation of the tissue structures undergoing diagnoses on a virtual model of the patient; and alignment of ultrasound cases volumes with a virtual patient body to produce an adapted patient body, among other features. The invention, however, may be embodied in many different forms and should not be construed as being limited to the exemplary embodiment set forth here. The exemplary embodiment is provided so that this disclosure will be thorough, be complete, and fully convey the scope of the invention to those skilled in the art.

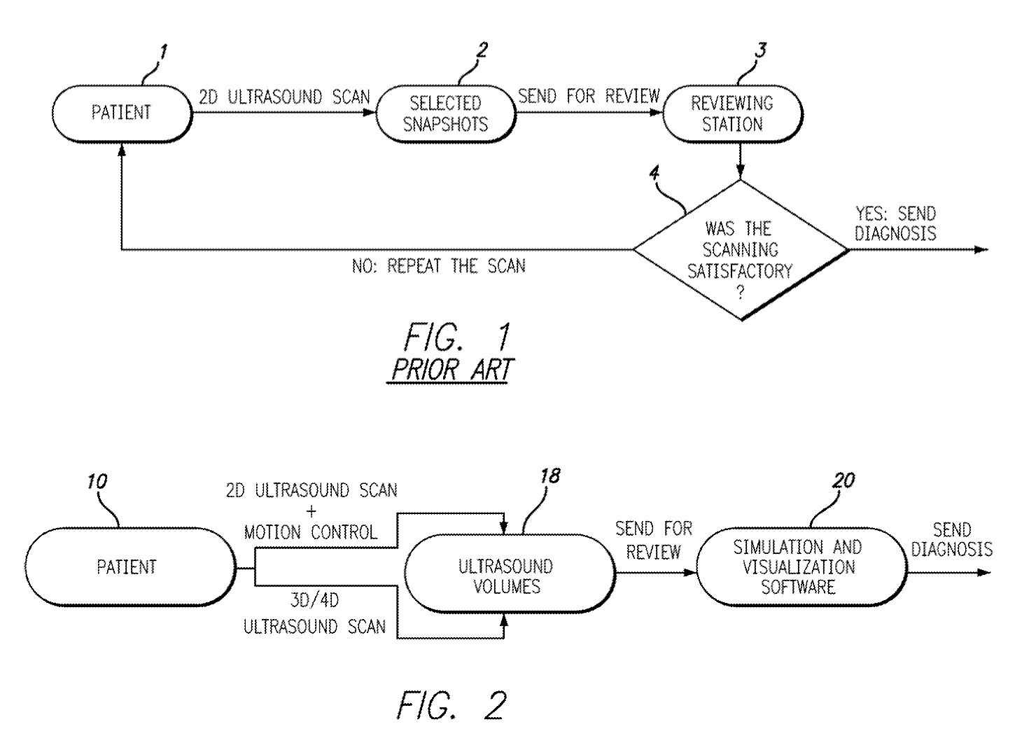

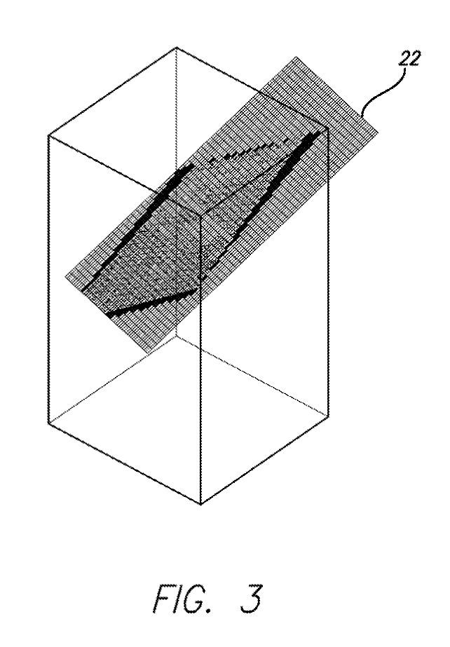

Referring now to FIG. 2, in the workflow of the present invention, a patient 10 is prepared for ultrasound imaging. An ultrasound case volume 18 is taken of the patient's anatomical areas of interest, i.e. tissue structure of interest. The ultrasound case volume 18 is then modified by the acquisition and processing system 20 for specialized simulation and visualization by the radiologist. The radiologist's diagnosis is then sent to the treating physician.

In the above workflow, traditional ultrasonography is augmented or replaced by modern techniques for acquiring and storing ultrasound data in a volumetric format, i.e. in ultrasound case volumes 18. In an ultrasound case volume 18, the data is organized in a 3D spatial grid, where each grid cell corresponds to a data point acquired by the ultrasound device in 3D space. Such case volumes 18 can also be acquired directly with a modern 3D/4D ultrasound machine that provides built-in support for volumetric ultrasound.

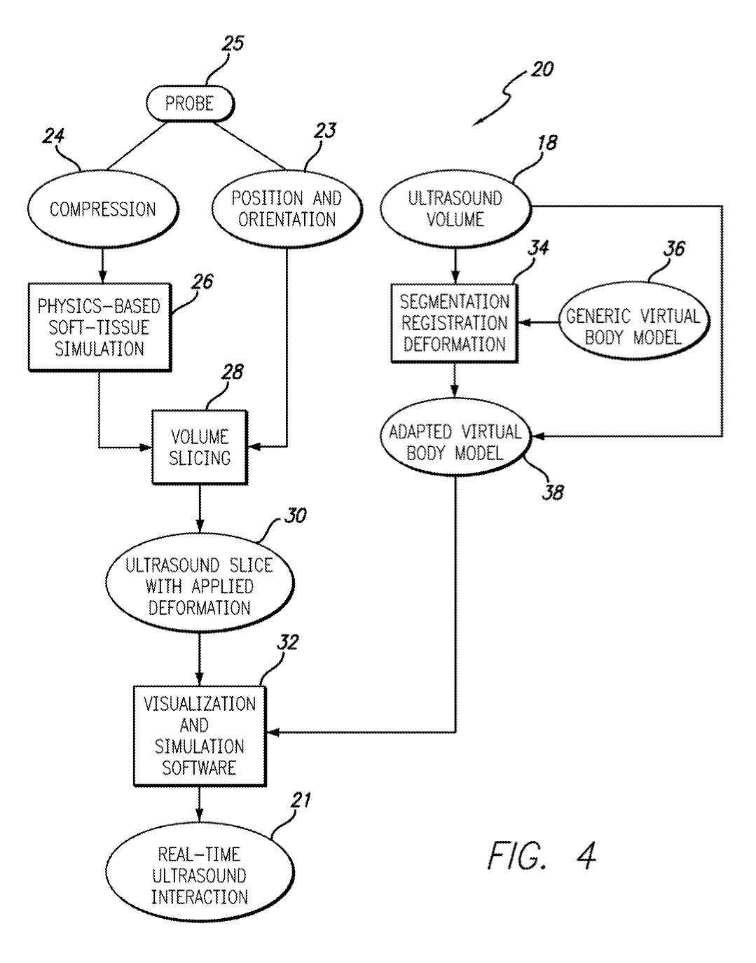

If direct support for volume ultrasound acquisition is not available, ultrasound volumes 18 can be obtained using existing 2D ultrasound probes coupled with motion-sensing equipment, such as inertial, optical, or electromagnetic 3D trackers (not shown). Ultrasound images are captured directly from the video output of the ultrasound machine and transmitted to the system 20 in digital form along with precise data that measures the position and orientation of an ultrasound probe 25 (see FIG. 4) in 3D space. This information is used to register each ultrasound image accurately in 3D space. Individual image slices 22 (see FIG. 3) are then interpolated in 3D to fill the ultrasound volume completely. Depending on the type and accuracy of the motion traces it may be required to calibrate the system so that pixel positions in each ultrasound image can be mapped to positions in 3D space. Furthermore, since the characteristics and geometry of the acquired images change substantially based on the type of probe that was used and the settings on the ultrasound machine, the acquisition and processing system 20 may need additional information to account for these additional parameters when an ultrasound volume 18 is constructed.

Even if a 3D/4D ultrasound probe is available, the relative body area of the acquired volumes 18 (scanned surface area) is generally small, which limits the ability of the reviewer to sweep through a simulated case translationally. To overcome this problem, multiple adjacent volumes 18 may be aligned and stitched together to provide larger coverage of the anatomical region of interest. While the latter could be done manually using specialized software, the preferred approach would be to use motion control for an approximate alignment of adjacent volumes followed by a subsequent application of registration algorithms for refined stitching of the volume boundaries.

Once a collection of ultrasound case volumes 18 is acquired from the patient 10, the data is then transmitted to a dedicated work station or computer 21 (see FIG. 4) of the acquisition and processing system 20 for visualization and simulation of the data. Data may be transmitted in a variety of ways, which are already widespread in medical practice (over the Internet, on physical media, or other specialized digital communication channels). Volumetric ultrasound data may be stored either in a specialized custom format or in a standardized medical format, such as DICOM.

The enhanced review station 21 uses an advanced visualization and simulation software module 32 (see FIG. 4) to provide the ability to interact with a given ultrasound volume 18 as if the device was being used directly on a real patient. Upon reviewing the ultrasound volume 18 using the acquisition and processing system of the present invention 20, a radiologist may transmit his or her diagnosis to the treating physician.

Referring now to FIG. 4, in one embodiment, the acquisition and processing system 20 operates with a 2D ultrasound probe 25 equipped with a six degree-of-freedom spatial tracking device as follows: Spatial location and orientation data 23 from the ultrasound probe 25 is supplied to the acquisition and processing system 20. Compressive force data 24, if available is supplied to the acquisition and processing system 20. The system combines the 2D ultrasound scans with the spatial orientation data to produce a simulated 3D ultrasound case volume 18. Subsequently, a 2D slice 22 (see FIG. 3) is made of the tissue structure of interest by a volume slicing module 28. Compressive force data 24 is utilized to create an ultrasound slice with applied deformation 30. The ultrasound slice with applied deformation 30 is visualized for review by the radiologist or treating physician on the workstation or computer 21.

The input device to the review station or computer 21 is a handheld ultrasound probe 25 that, in the embodiment shown in FIG. 4, is a 2D probe equipped with a spatial tracking sensor capable of measuring spatial position and orientation data 23 plus an additional compressive force sensor for reading of applied compression 24 that is triggered by pressing the tip of the device against a surface.

With the availability of compressive force data, a physics-based software algorithm 26 can apply real-time deformation data to the ultrasound slice 22 (see FIG. 3), to produce an ultrasound slice with applied deformation 30. The applied deformation slice 30 mimics how internal tissues respond to mechanical pressure. Physics-based soft-tissue simulation 26 can be implemented using a variety of techniques found in the technical literature, including the Finite-Element Method (FEM), Finite-Volume Method (FVM), spring-mass systems, or potential fields. The acquisition and processing system 20 is capable of combining the 2D ultrasound scans with the probe's 25 position and orientation information 23 to create a 3D ultrasound case volume 18.

Given an ultrasound volume 18, a slicing algorithm 28 samples the ultrasound case volume elements in 3D space along the surface of an oriented plane (slicing plane) to produce a 2D-image 22 (see FIG. 3). The position and orientation of the slicing plane are defined preferably by the ultrasound probe 25 equipped. The probe 25 can be manipulated in space or on a surface in a way that is closely reminiscent of how a real ultrasound probe is handled. Alternatively, a user interface may be provided to define the slicing plane with a mouse, keyboard, trackball, trackpad, or other similar computer peripheral. The purpose of the slicing algorithm 28 is to reconstruct a visualization of the original ultrasound data that is as close as possible to the image that would be seen if the real ultrasound probe was used on the same patient.

To successfully review an ultrasound case, the reviewer needs to correlate the ultrasound image on screen with the underlying patient anatomy. Therefore, it is important to inform the reviewer about the exact location of the ultrasound probe 25 in relation to the patient's body. In traditional workflow, this information is relayed to the reviewer in a writing affixed to ultrasound still images or video clips. But this does not provide the reviewer with sufficient perspective or real-time information regarding where the ultrasound probe was at the time of the corresponding image capture because the description is often qualitative, vague, and does not define the anatomical position of the scan accurately.

In the present invention 20, a 3D-virtual body 36 is presented on the screen of the review station 21 along with a visual representation of the ultrasound probe 25 at the exact location where the original ultrasound scanning occurred on the patient's body. A high-fidelity visualization of the virtual body 36 can be generated using any off-the-shelf commercial-grade graphics engine available on the market. A virtual body model that externally scales to the morphologic characteristics of the patient is adequate for this purpose.

The value of the disclosed workflow is greatly enhanced by creating an adapted virtual body model 38. The adapted virtual body model is created by matching the morphology of internal anatomical areas of interest in the generic virtual body 36 with detailed characteristics of the ultrasound data set(s) 18. This matching is achieved by a segmentation module 34 which segments the geometry of relevant tissues from ultrasound case volume(s) 18.

Segmentation of ultrasound volumes can be either performed manually, using specialized automated algorithms described in the technical literature and available in some commercial grade software applications, or by registering the ultrasound volume against CT-scans or MRI scans of the same patient if available. Once segmented ultrasound volumes are provided, surface deformation algorithms are used to deform the geometry of the generic virtual body model to conform to the exact characteristics of the desired ultrasound case. Additionally, the internal anatomy (area of interest) may be scaled so that the overall body habitus of the virtual patient matches the physical characteristics of the patient. Using the simulation and visualization software and system 20 of the present invention, a radiologist is readily able to review ultrasound results independent of the patient, the type of ultrasound machine used to acquire the original data, and the original scanning session, i.e., the reviewer can interact with the data at the time of his or her choosing.

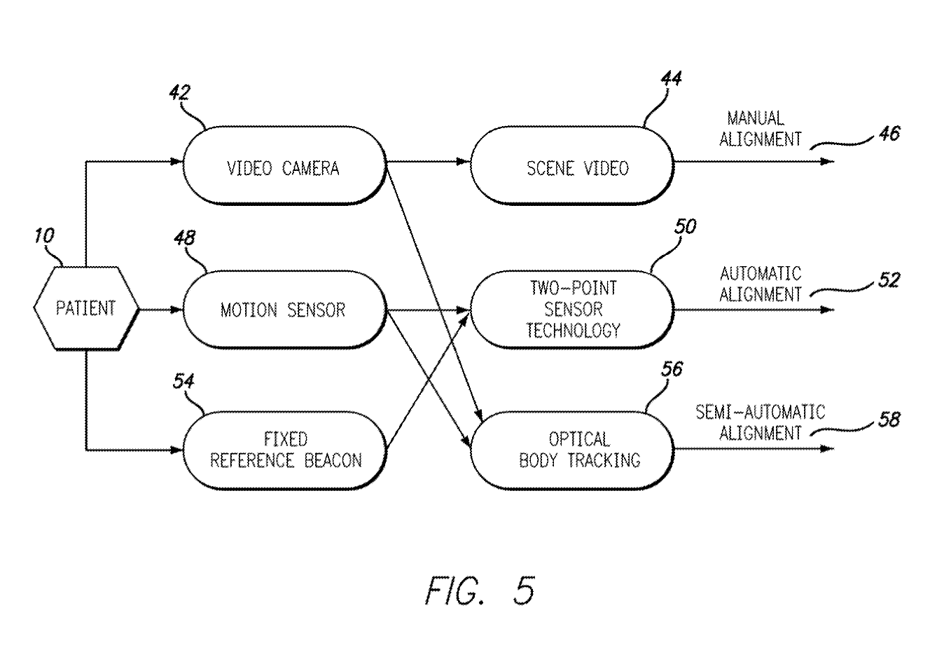

Referring now to FIGS. 4 and 5, in order to place a virtual probe model at the exact position on the virtual body 38 corresponding to the simulated ultrasound image, it is necessary to know where the captured 3D ultrasound volumes reside with respect to the patient's body. This problem is referred to in the art as body alignment. In the disclosed workflow, body alignment can be achieved using several alternative methods that offer various tradeoffs in terms of automation and cost. After use, patient-derived imagery must be de-identified to meet federal regulatory patient confidentiality and protected health information requirements.

Manual alignment 46—Using a standard low-cost video camera 42, the ultrasound technician records a video of the scene 44, while the patient is being scanned. The video 44 must show clearly the patient's body and the ultrasound probe. The video recording is then used as a reference for positioning and orienting the relevant ultrasound volumes 18 with respect to the virtual body 38. The patient-derived imagery must be de-identified to meet federal regulatory patient confidentiality and protected health information requirements.

Semi-Automatic Alignment 58—Using modern advances in optical technologies and computer vision, the body of the patient can be measured directly in 3D with low-cost cameras 42. A motion-controlled ultrasound probe 48 is then used to detect the position of the probe with respect to the optically measured body reference frame. Additional manual adjustment may be required to refine the alignment using the scene video 44.

Automatic Alignment 58—In some cases it is feasible to use a two-point tracking solution 50, where a reference beacon 54 is carefully placed at a designated location on the patient's body and an additional motion sensor 48 is used to measure the position and orientation of the motion tracking probe 48 with respect to the fixed beacon 54.

Upon integration of patient-specific ultrasound volumes 18 into a virtual patient 38 whose external morphologic characteristics and internal anatomy are scaled and configured to match the patient's external and internal anatomy, the system 20 can be used for pre-procedural rehearsal of needle based medical procedures. Operators can interact with ultrasound case volumes 18 using virtual needles that interact with simulated real-time ultrasound image guidance. The visualization and simulation engine 32 (see FIG. 4) will manage all the assets and emulate the interactions that characterize image guided needle insertion in the clinical setting.

The disclosed method of the present invention for real-time reconstruction and creation of complete 3D ultrasound data sets uses low-cost widely available 2D ultrasound machines and expands the aforementioned benefits to a broad spectrum of clinical settings, ultrasound machines, and operators. This improves an operator's ability to examine and interact with a patient's complete ultrasound data independent of the patient, the type of ultrasound machine (2D or 3D) used to acquire the original data, and the original scanning session (i.e., the reviewer can interact with the data at the time of his/her choosing). As a result, the disclosed workflow mitigates the need to have a patient return for additional image acquisition and having the radiologist at the bedside to observe the ultrasound examination while it is being taken. This solution provides an opportunity for pre-procedural rehearsal of these needle-based procedures under ultrasound-image guidance using a patient's anatomical imagery. Operators will be able to practice and rehearse needle-based surgical procedures using real-time ultrasound image guidance on a patient's anatomic ultrasound data prior to actually performing the procedure.

Alternative embodiments include: (1) integration into teleradiology workflow solutions. case volumes can be transmitted from the patient's bedside to a remote location where a trained reviewer can scan through the volume of ultrasound data and analyze and interpret the findings; (2) case volumes can be distributed to students for purposes of testing, credentialing, or certification. A user would scan through the volumes of data while an assessor reviews their ability to scan through the volumes of ultrasound data and detect relevant pathology.

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

### INDUSTRIAL APPLICABILITY

This invention may be industrially applied to the development, manufacture, and use of machines and processes for conducting ultrasound scans

What is claimed is:

1. A method for 3D ultrasound interaction, comprising:
(a) supplying a generic virtual body model, the generic virtual body model having a morphology;
(b) supplying a 3D ultrasound case volume, the 3D ultrasound case volume having a morphology, where the case volume contains ultrasound imagery of anatomical structures of a patient comprising ultrasound data collected by an ultrasound device;
(c) producing an adapted virtual body model by aligning the morphology of the ultrasound case volume to the morphology of the generic virtual body model; and
(d) visualizing the adapted virtual body model using graphics software on a computing device.

2. The method of claim 1, where the 3D ultrasound case volume comprises 2D ultrasound scans taken with an ultrasound probe also generating spatial position data and orientation data while the ultrasound probe is capturing the 2D ultrasonic scans, the 3D ultrasound case volume being interpolated from the 2D ultrasound scans, the spatial position data, and the orientation data.

3. The method of claim 1 further including the steps of sampling a 2D ultrasound slice from the 3D ultrasound case volume, the slice including compression data, and conducting a physics-based soft-tissue simulation with the compression data to simulate tissue structure deformation on the 2D ultrasound slice.

4. The method of claim 1, where the step of aligning the morphology of the ultrasound case volume to the morphology of the generic virtual body model is performed manually by recording a video of the patient undergoing an ultrasound scan and then using the video to orient the 3D ultrasound case volume on the generic virtual body model.

5. The method of claim 1, where the step of aligning the morphology of the ultrasound case volume to the morphology of the generic virtual body model is performed semi-automatically by optically measuring the patient, scaling the generic virtual body model to conform to the optically measured patient, using an ultrasound probe to generate spatial position data and orientation data, and superimposing the 3D ultrasound case volume on the optically measured patient using the position data and orientation data.

6. The method of claim 1, where the step of producing the adapted virtual body model is performed by placing a reference beacon at a designated location on the patient, measuring the position and orientation of an ultrasound probe with respect to the reference beacon, the ultrasound probe being equipped with a six degree-of-freedom motion sensor, and then superimposing the 3D ultrasound case volume on the generic virtual body model.

7. The method of claim 1, where the ultrasound data in the 3D ultrasound case volume is organized in a 3D spatial grid comprising grid cells, and each grid cell corresponds to a data point acquired by the ultrasound device.

8. A method for ultrasound interaction with compressive force deformation, comprising:
(a) supplying a 3D ultrasound case volume, the case volume containing ultrasound imagery comprising ultrasound data collected by an ultrasound device, of anatomical structures of a patient;
(b) creating a 2D image slice from the 3D ultrasound case volume;
(c) supplying compression data correlated to the 2D image slice;
(d) creating a physics-based soft-tissue anatomical model of the 2D image slice;
(e) applying the compression data to the anatomical model to produce a deformed 2D ultrasound slice; and
(f) visualizing the deformed 2D ultrasound slice using graphics software on a computing device.

9. The method of claim 8, where the 3D ultrasound case volume comprises 2D ultrasound scans taken with an ultrasound probe also generating spatial position data and orientation data while the ultrasound probe is capturing the 2D ultrasonic scans, the 3D ultrasound case volume being interpolated from the 2D ultrasound scans, the spatial position data, and the orientation data.

10. The method of claim 8, where the ultrasound data in the 3D ultrasound case volume is organized in a 3D spatial grid comprising grid cells, and each grid cell corresponds to a data point acquired by the ultrasound device.

11. A system for acquiring and processing 3D ultrasound data, comprising:
(a) a generic virtual body model, the generic virtual body model having a morphology;
(b) a 3D ultrasound case volume, the 3D ultrasound case volume having a morphology, the case volume containing ultrasound imagery of anatomical structures of a patient;
(c) an adapted virtual body model formed by aligning the morphology of the ultrasound case volume to the morphology of the generic virtual body model; and
(d) a display screen showing the adapted virtual body model.

12. The system of claim 11, where the 3D ultrasound case volume comprises 2D ultrasound scans taken with an ultrasound probe also generating spatial position data and orientation data while the ultrasound probe is capturing the 2D ultrasonic scans, the 3D ultrasound case volume being interpolated from the 2D ultrasound scans, the spatial position data, and the orientation data.

13. The system of claim 11, where the 3D ultrasound case volumes comprise compressive force data that is acquired and incorporated during an ultrasound scanning session, the compressive force data representing an ultrasound probe pressure asserted upon the patient during the ultrasound scanning session.

14. The system of claim 13, where a 2D ultrasound slice is sampled from the 3D ultrasound case volume and a physics-based soft-tissue simulation is created with the compressive force data to simulate tissue structure deformation on the 2D ultrasound slice.

15. The system of claim 11, where the adapted virtual body model is produced by manually aligning the 3D ultrasound case volume to the generic virtual body model by recording a video of the patient undergoing an ultrasound scan, wherein the video may be used to orient the 3D ultrasound case volume on the adapted virtual body model.

16. The system of claim 11, where the adapted virtual body model is semi-automatically aligned by associating position data and orientation data to the ultrasound case volume, optically measuring the patient, scaling the generic virtual body model to conform to the optically measured patient, and superimposing the ultrasound case volume on the optically measured body using the position data and orientation data.

17. The system of claim 11, wherein the adapted virtual body model is aligned with an ultrasound case volume by locating a reference beacon at a designated location on the patient and tracking the position and orientation of an ultrasound probe, equipped with a six degree-of-freedom motion sensor, with respect to the reference beacon, where the adapted virtual body is produced by superimposing the tracked ultrasound case volume on the generic virtual body model.
